(19) United States
(12) Patent Application Publication
(10) Pub. No.: US 2009/0315362 A1
(43) Pub. Date: Dec. 24, 2009

(54) Straight trajectory sliding shutter apparatus

(76) Inventors: Alisa Michnik, Cherry Hill, NJ (US); Yefim Michnik, Cherry Hill, NJ (US)

Correspondence Address: ALISA MICHNIK;YEFIM MICHNIK, 23 CLEMSON RD., CHERRY HILL, NJ, 08034, US

(21) Appl. No.: 12/214,908

(22) Filed: Jun. 24, 2008

(51) Int. Cl. B60J 5/06

(52) U.S. Cl. 296/155

(57) ABSTRACT

A sliding shutter apparatus comprising an opening of a predetermined shape, a shutter adapted to seal the opening in closed position and unseal the opening in opened position, and guiding means for facilitating movement of the shutter along a single straight line trajectory between opened and closed positions.

### BACKGROUND OF THE INVENTION

1. Field of the Invention

The present invention is applicable for sealing openings by sliding shutters in a straight trajectory between opened and closed positions.

2. Background of the Invention

The present invention is a straight trajectory sliding shutter apparatus which can be used, for instance, for sealing sliding doors and windows. As an example, a car sliding door application will be described herein.

Sealing doors for cars is a must. As of now, sealing with sliding doors has been achieved by using complex trajectories resulting in complex designs and, therefore, expensive installations. In addition, these doors are hard to move. It seems, those are the reasons behind the fact that only one or two rear sliding doors are installed in passenger cars, such as vans, nowadays. For the same reasons, simple applications, for instance, for household closets are not economical at the present time.

For instance, U.S. Pat. No. 7,121,042 issued on Oct. 17, 2006 and U.S. Pat. No. 7,243,978 issued on Jul. 17, 2007 describe such sliding doors where movement between opened and closed positions requires a two-step process. Generally, one step is a movement of the sliding door parallel to an opening, and another step is a movement toward or away from the opening.

Consequently, there is a need for a sliding door that can be easily moved while reducing number of related parts and cost. This invention achieves this while overcoming the disadvantages of the prior art devices.

### OBJECTS OF THE INVENTION

Accordingly, several objects and advantages of the present invention are:

To provide an economical device which makes it easy to afford numerous sliding shutters at the same time, for instance, four sliding doors for any type of car.

To provide a device which is easy to use since sealing and unsealing of an opening is achieved in a single step with minimum force required.

To provide a safe device, for instance, if a person happens to be inside of a vehicle trapped underwater, they will be able to open the door by simply sliding it and escaping out of the vehicle rather than having to fight the water pressure.

To provide a protective device where, for instance, guiding means of a sliding door will double as side impact protection means.

To provide a practical device which, for instance, in case of a car requires less car parking space while protecting the surrounding cars from scratches.

To provide a convenient device where the shutter movement can be easily automated.

Further objects and advantages of this invention will become apparent from a consideration of the drawings and ensuing description.

### SUMMARY OF THE INVENTION

The present invention may be generally described as a sliding shutter apparatus comprising an opening and a shutter adapted to seal the opening in closed position and unseal the opening in opened position with a single straight trajectory step. As a result, the construction of such apparatus is simplified reducing the costs and making it much easier to use and more convenient to automate. Applications of this invention can be as simple as a sealed closet where the shutter perimeter is two-dimensional and can be as sophisticated as a sealed vehicle door where the shutter perimeter is multi-dimensional.

The apparatus also includes simple guiding means which are provided for facilitating movement of the shutter between opened position and closed position along the straight line trajectory. For instance, guiding means implemented as guiding beams for a car application leave enough space for passenger compartment storage and hardware for windows and locks while protecting passengers from side impacts.

The features briefly described in this summary as well as other features and advantages of this invention will become apparent to those skilled in the art upon review of the following drawings, the detailed description, and the appended claims.

### BRIEF DESCRIPTION OF THE DRAWINGS

FIG. 1 is a perspective view of a straight trajectory sliding shutter apparatus showing the shutter in closed position;

FIG. 2 is a side view of the straight trajectory sliding shutter apparatus depicted in FIG. 1;

FIG. 3 is a perspective view of a straight trajectory sliding shutter apparatus showing the shutter in opened position;

FIG. 4 is a side view of the straight trajectory sliding shutter apparatus depicted in FIG. 3;

FIG. 5 is a side view of a car with the straight trajectory sliding doors shown in closed position;

FIG. 6 is a view of the doors' perimeter rubber of the car depicted in FIG. 5;

FIG. 7 is a side view of a car with the straight trajectory sliding doors shown in opened position;

FIG. 8 is a view of the car perimeter rubber and the doors' perimeter rubber of the car depicted in FIG. 7;

FIG. 9 is a top view of a car with the straight trajectory sliding doors shown in closed position;

FIG. 10 is a view of the doors' perimeter rubber located on the bottom side of the car depicted in FIG. 9;

FIG. 11 is a top view of a car with the straight trajectory sliding doors shown in opened position;

FIG. 12 is a view of the car perimeter rubber and the doors' perimeter rubber located on the bottom side of the car depicted in FIG. 11;

FIG. 13 is a front view of a car with the straight trajectory sliding doors shown in closed position;

FIG. 14 is a view of the doors' perimeter rubber of the car depicted in FIG. 13;

FIG. 15 is a front view of a car with the straight trajectory sliding doors shown in opened position;

FIG. 16 is a view of the doors' perimeter rubber of the car depicted in FIG. 15;

FIG. 17 is a perspective view of guiding means located inside of the a straight trajectory sliding door in closed position;

FIG. 18 is a perspective view of the guiding means depicted in FIG. 17 without cover panels;

FIG. 19 is a side view of the guiding means depicted in FIG. 17;

FIG. 20 is a side view of the guiding means depicted in FIG. 19 without cover panels;

FIG. 21 is a front view of the guiding means depicted in FIG. 17;

FIG. 22 is a top view of the guiding means depicted in FIG. 21;

FIG. 23 is a front view of the guiding means depicted in FIG. 21 shown in opened position;

FIG. 24 is a top view of the guiding means depicted in FIG. 23;

FIG. 25 is a perspective view of a sample track configuration;

FIG. 26 is a perspective view of another sample track configuration;

FIG. 27 is a side view of a car with door handles;

FIG. 28 is a cross-sectional view of a locking mechanism connected to the door handles of the car depicted in FIG. 27 taken along line 28-28;

FIGS. 29-32 are views of the locking mechanism depicted in FIG. 28 in various positions during the process of locking and unlocking a straight trajectory sliding door.

### DETAILED DESCRIPTION OF THE INVENTION

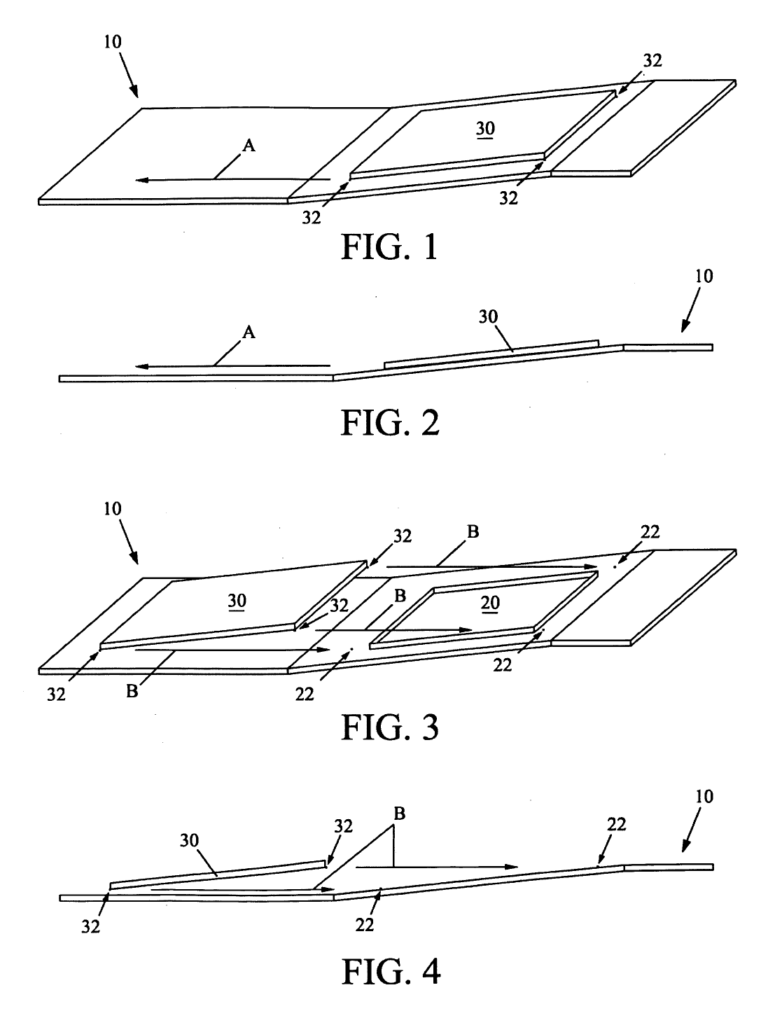

The concept of the invention is demonstrated in FIGS. 1-4. The straight trajectory sliding shutter apparatus 10 comprises an opening 20 and a shutter 30 adapted to seal the opening 20 in closed position (FIGS. 1 and 2) and unseal the opening 20 by sliding away (arrow A) from closed position (FIGS. 3 and 4). Each point 32 on the perimeter of the shutter 30 has only one corresponding point 22 on the perimeter of the opening 20 defining a pair of points. The points of each pair merge in closed position (FIG. 1). Each pair of points defines a single straight line trajectory (arrow B) the points 22 and 32 are located on in any shutter position (FIGS. 3 and 4). All of the trajectories are parallel. The distance between points 22 and 32 of each pair are equal in any one of the shutter positions.

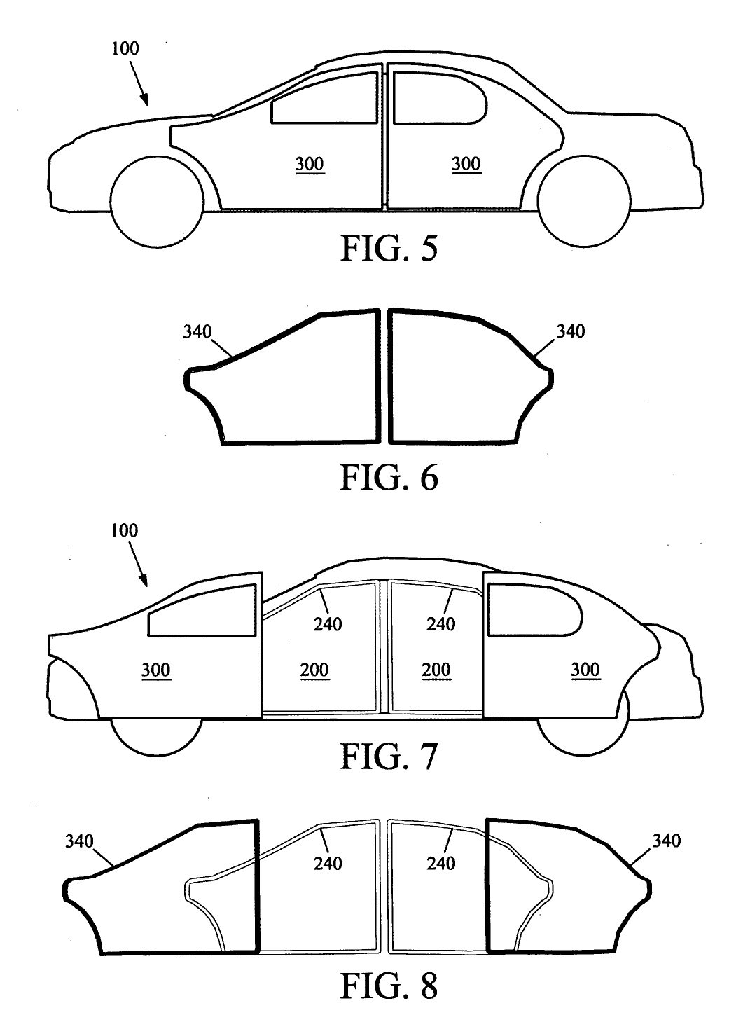

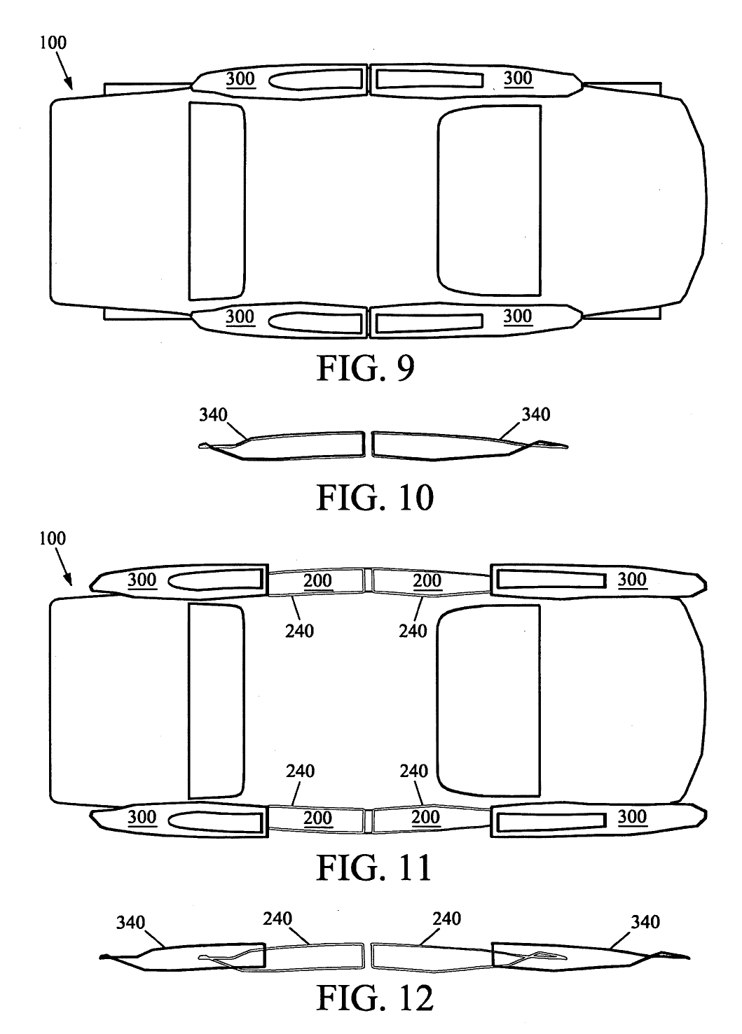

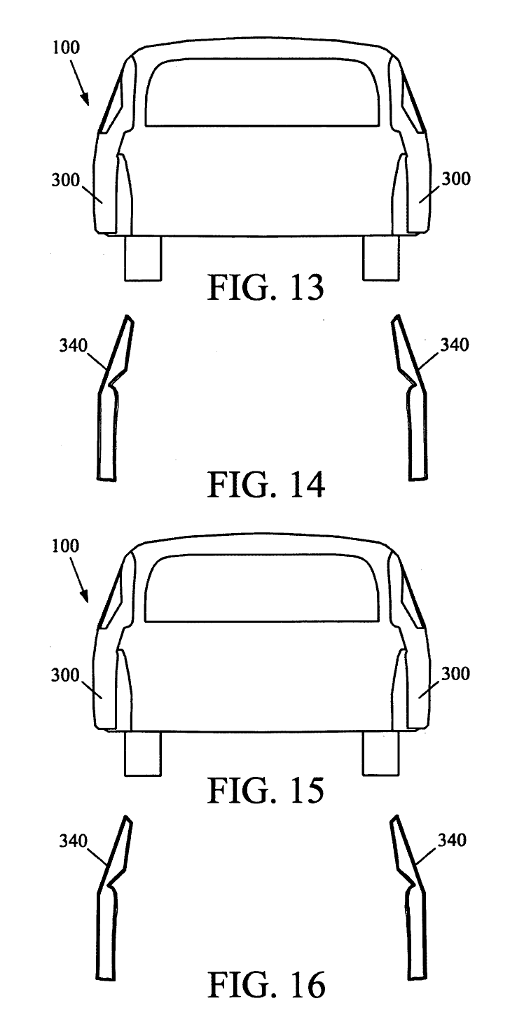

For demonstrative purposes, a car sliding door application is demonstrated in FIGS. 5-27. The car 100 comprises four openings 200 (best seen in FIG. 11) and four doors 300 adapted to seal the openings 200 in closed position (FIGS. 5, 9, and 13) and unseal the openings 200 by sliding away from closed position (FIGS. 7, 11, and 15). The perimeter of each opening 200 comprises a rubber tube 240 and the perimeter of each door 300 comprises a complementary rubber tube 340 (best seen in FIGS. 8, 12, and 16) adapted to engage with the car perimeter rubber tube 240 ensuring a tight seal when in closed position (FIGS. 6, 10, and 14).

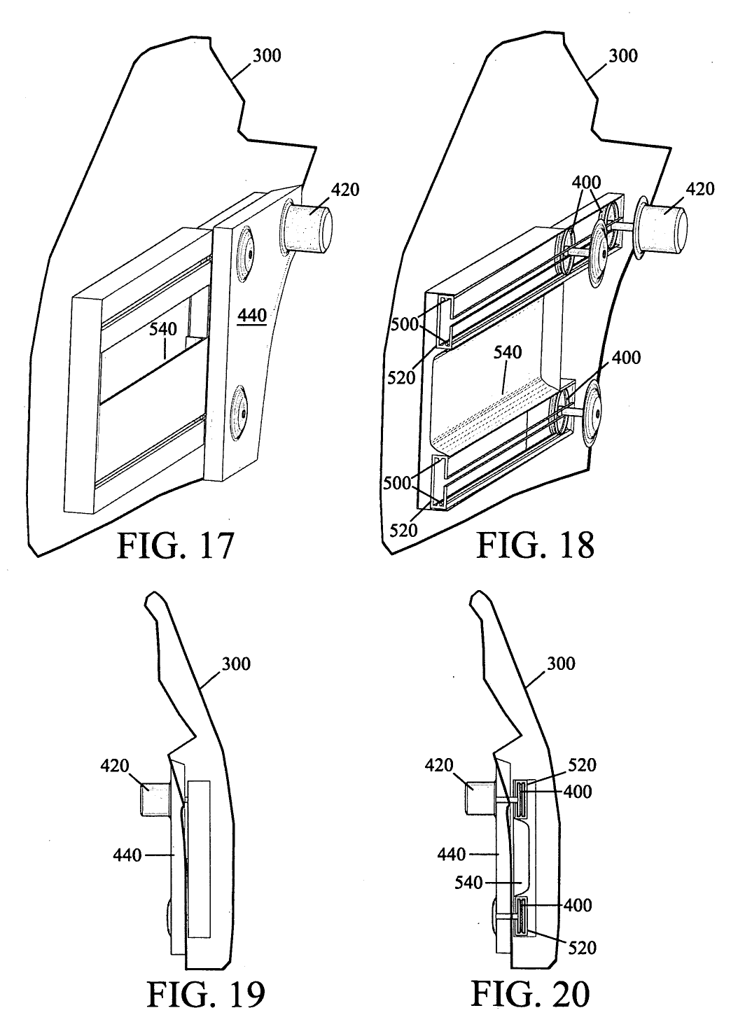

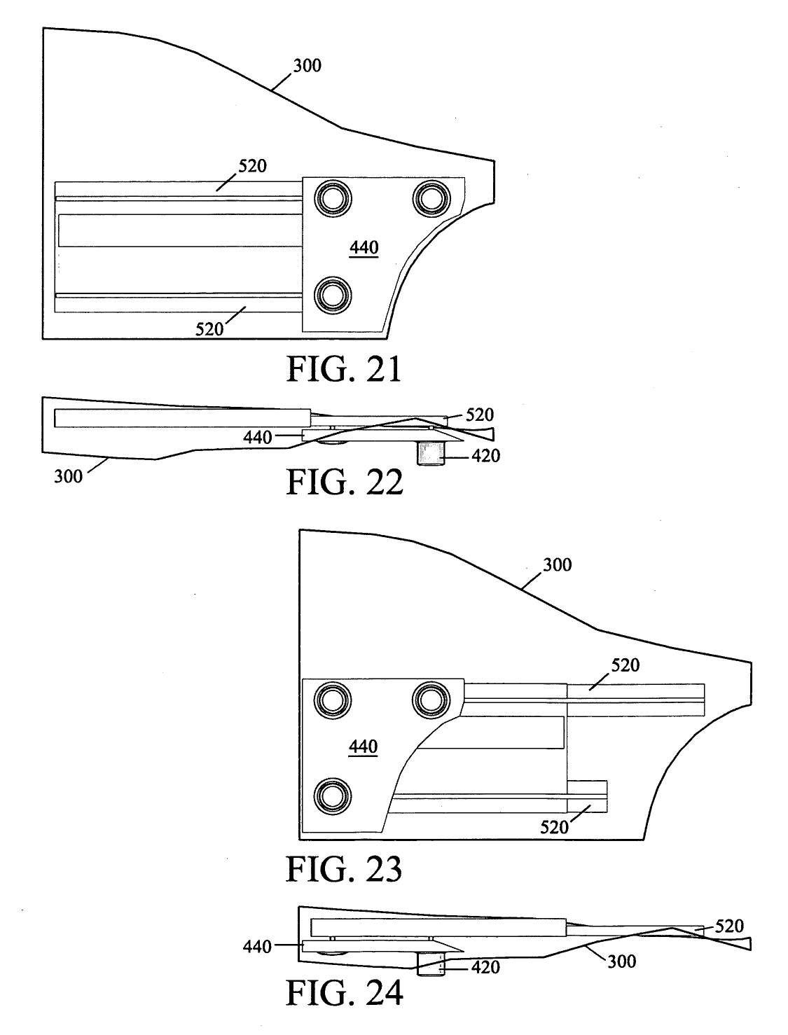

For exemplary purpose, the straight trajectory of each door 300 is achieved by guiding means comprising three wheels 400 attached to a car frame 440 and two door channels 520 (FIGS. 17-24), each of the channels 520 comprises two straight tracks 500 on the inside (best seen in FIG. 18). Each of the wheels 400 slide between the tracks 500 of the channel 520 between the opened and closed positions (FIGS. 21-24). The area between the two channels 520 can be used, for instance, as a passenger storage compartment 540 (FIGS. 17 and 18). FIGS. 17-24 depicts a power train 420 attached to a wheel 400 for the purpose of automatic movement of the door 300 between the closed and opened positions.

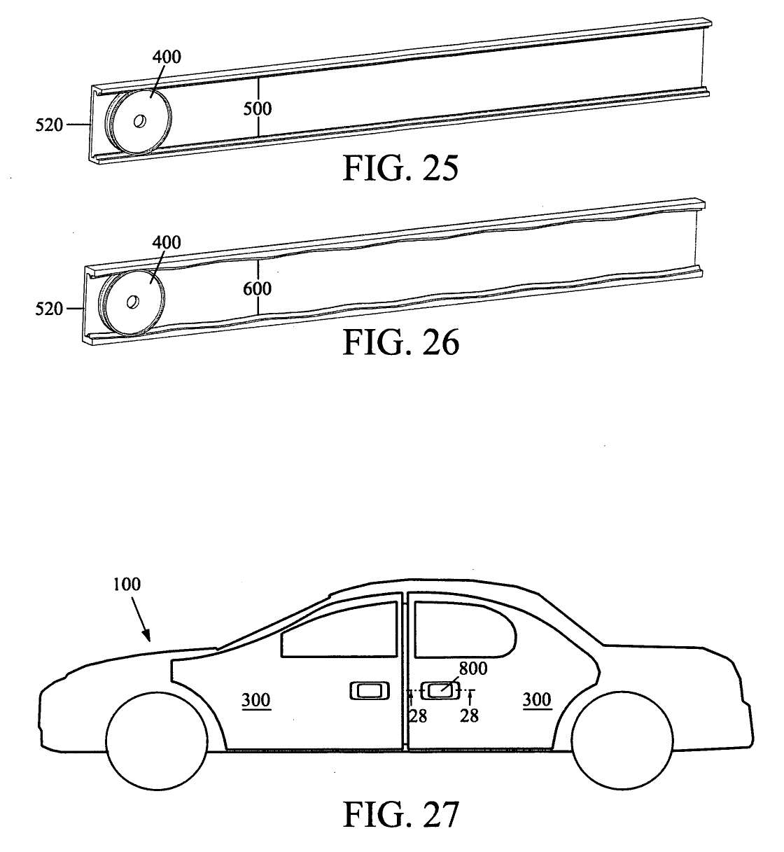

FIGS. 25 and 26 depict two sample configurations of tracks 500 and 600. FIG. 25 depicts a straight track 500 requiring minimum effort for sliding the doors 300. FIG. 26 depicts a wave-like track 600 being a spring or made of a predetermined elastic material requiring predetermined force applied to the wheels 400 for sliding the door 300 along the track 600 for the purpose of preventing undesired door opening on a hill as a result of gravity.

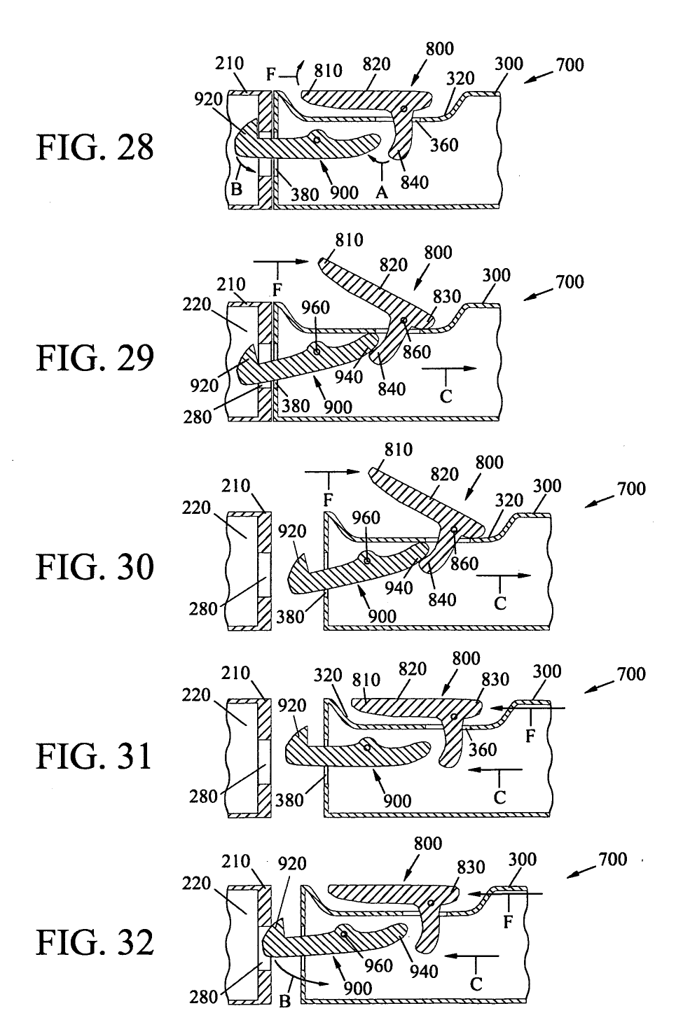

FIG. 27 demonstrates a door handle 800 for moving the door 300 between opened and closed positions. FIGS. 28-32 demonstrate a locking mechanism 700 for locking and unlocking of the door 300 in closed position. Parts of the locking mechanism 700 located in the door 300 comprises a handle 800, a handle pivot 860, a handle torsion spring located on the handle pivot 860 (not shown) for keeping the handle 800, when decompressed, in a position shown in FIGS. 28 and 31, an indented section 320 with a cutout 360, a locking arm 900, a locking arm pivot 960, a locking arm torsion spring located on the locking arm pivot 960 (not shown) for keeping the locking arm 900, when decompressed, in a position shown in FIGS. 28 and 31 and a cutout 380. Parts of the locking mechanism 700 located in the car frame 210 comprises a cutout 280 and a hollow space 220.

The handle 800 comprises a handling portion 820 and a contacting portion 840 (best seen in FIG. 28). The handling portion 820 comprises two ends where end 810 is used for opening the door 300 and end 830 is used for closing the door 300 (best seen in FIG. 29). The handle 800 is positioned inside the cutout 360 with the contacting portion 840 located inside of the door 300 and the handling portion 820 located in the indented section 320 on the outside of the door 300 (best seen in FIG. 28). The locking arm 900 comprises a pointed locking member 920 at one end and a contact area 940 at the other end. The locking arm 900 is positioned inside of the cutout 380 with the pointed locking member 920 located outside of the door 300 and the arm contact area 940 located inside of the door 300 (best seen in FIG. 30).

As shown in FIG. 28, unlocking of the door 300 is achieved by applying force F by pulling the handling portion end 810 around the pivot point 860 in the direction of arrow F compressing the handle spring (the spring is not shown). As a result, the handle contacting portion 840 pivots about the pivot 860 in the direction of arrow A pushing the arm contact area 940 resulting in the pointed locking member 920 to pivot about the pivot 960 in the direction of arrow B compressing the arm spring (the spring is not shown) at which point, the door 300 is unlocked from the car 100 (FIG. 29). Once the door is unlocked, without letting go of the handling portion end 810, opened position is achieved by further applying force F to the handling portion end 810 in the direction of arrow F (FIG. 30) resulting in the door 300 to slide in the direction of arrow C until the door 300 has reached opened position. When the handling portion end 810 is released (FIG. 31), the handle 800 is returned to the initial position by decompressing force of the handle spring and the locking arm 900 is returned to the initial position by decompressing force of the arm spring (the springs are not shown).

As shown in FIG. 31, locking of the door 300 is achieved by applying force F by pushing on the handling portion end 830 in the direction of arrow F and sliding the door 300 in the direction of arrow C. As the pointed locking member 920 encounters the edge of the car frame 210 (FIG. 32), the pointed locking member 920 starts to pivot about the pivot 960 in the direction of arrow B compressing the arm spring and continuing to pivot as the door 300 continues to slide in the direction of arrow C until the pointed locking member 920 is inserted in the hollow space 220 of the car 100 resulting in locking the door 300 to the car 100 by decompression force of the arm spring (FIGS. 27 and 28).

Those who are skilled in the art will readily perceive how to modify the invention. Therefore, the appended claims are to be construed to cover all equivalent structures which fall within the scope and spirit of the invention.

What is claimed is:

1. A straight trajectory sliding shutter apparatus, comprising:
a. an opening of a predetermined shape;
b. a shutter adapted to seal said opening in closed position and unseal said opening in opened position, said shutter being movable between said closed position and said opened position, each point on the perimeter of said shutter has only one corresponding point on the perimeter of said opening defining a pair, said pair points being merged in said closed position, said pair points defining a straight line in said opened position, said shutter pair point being located on said line in any one of said shutter positions ranging from said closed position to said opened position, straight lines defined by each of said pairs in said opened position being parallel, distance between said pair points being equal for all pairs in any one of said shutter positions ranging from said closed position to said opened position;
c. guiding means facilitating said shutter movement between said opened position and said closed position.

2. The straight trajectory sliding shutter apparatus of claim 1, wherein said shutter being moved manually between said closed position and said opened position.

3. The straight trajectory sliding shutter apparatus of claim 1, wherein said shutter being moved automatically between said closed position and said opened position.

4. The straight trajectory sliding shutter apparatus of claim 1, wherein locking means preventing said shutter movement in a predetermined number of positions ranging from said closed position to said opened position when said locking means being engaged and allowing said shutter movement when said locking means being disengaged.

5. The straight trajectory sliding shutter apparatus of claim 1, wherein resistance means requiring a predetermined force applied to said shutter for controllable movement of said shutter between said closed position and said opened position.
